(19) United States
(12) Patent Application Publication
(10) Pub. No.: US 2022/0157049 A1
(43) Pub. Date: May 19, 2022

(54) TRAINING DATA GENERATOR, TRAINING DATA GENERATING METHOD, AND TRAINING DATA GENERATING PROGRAM

(71) Applicant: NEC Corporation, Minato-ku, Tokyo (JP)

(72) Inventor: Tetsuo INOSHITA, Minato-ku, Tokyo (JP)

(73) Assignee: NEC Corporation, Minato-ku, Tokyo (JP)

(21) Appl. No.: 17/435,825

(22) PCT Filed: Mar. 12, 2019
(86) PCT No.: PCT/JP2019/009921

§ 371 Date: Sep. 2, 2021

(51) Int. Cl. G06V 10/774; G06T 3/00; G06T 17/00

(52) U.S. Cl. CPC G06V 10/7747; G06T 17/00; G06T 3/0037

(57) ABSTRACT

A three-dimensional space generating unit 81 generates a three-dimensional space modeling a three-dimensional model with associated attributes and a first background in a virtual space. A two-dimensional object drawing unit 82 draws a two-dimensional object by projecting the three-dimensional model in the three-dimensional space onto a two-dimensional plane. A label generating unit 83 generates a label from the attributes associated with the three-dimensional model from which the two-dimensional object is projected. A background synthesizing unit 84 generates a two-dimensional image by synthesizing the two-dimensional object and a second background. A training data generating unit 85 generates training data that associates the two-dimensional image in which the second background and the two-dimensional object are synthesized with the generated label.

### TECHNICAL FIELD

The present invention relates to a training data generator, a training data generating method, and a training data generating program for generating training data used in machine learning.

### BACKGROUND ART

In machine learning using deep learning, etc., a large amount of training data is necessary for efficient learning. For this reason, various methods for efficiently creating training data have been proposed.

PTL 1 discloses an object recognition device that learns by generating 2D (2-Dimensions) images from 3D (3-Dimensions) computer graphics (CG). The object recognition device disclosed in PTL 1 generates a plurality of images of various shapes of hands in advance, learns based on the created images, and retrieves images of hands whose shapes are close to the input images at the time of recognition from the training images.

### CITATION LIST

### Patent Literature

PTL 1: Japanese Unexamined Patent Application Publication No. 2010-211732

### SUMMARY OF INVENTION

### Technical Problem

On the other hand, supervised learning requires training data with correct labels. However, it is very costly to collect a large amount of training data in which the correct labels are appropriately set and which are appropriate for the field.

The object recognition device disclosed in PTL 1 generates one 2D visible image (2D image projected onto a 2D plane) seen from a certain viewpoint for each motion frame from 3D CG basic motion image data. Therefore, it is possible to reduce the processing required to generate the training data. However, the object recognition device disclosed in PTL 1 has the problem that since the recognition target (e.g., hand recognition, body recognition, etc.) is fixed, only the correct label indicating whether or not it is a predetermined recognition target can be set in the training data.

In other words, even if the object recognition device disclosed in PTL 1 is used to virtually increase the number of pieces of data from 3D CG basic motion image data, it is difficult to automatically assign correct labels to according to types of data because only predetermined correct labels can be set.

Therefore, an object of the present invention is to provide a training data generator, a training data generating method, and a training data generating program capable of automatically generating training data with correct labels assigned according to types of data from CG

### Solution to Problem

A training data generator according to the present invention includes: a three-dimensional space generating unit that generates a three-dimensional space modeling a three-dimensional model with associated attributes and a first background in a virtual space; a two-dimensional object drawing unit that draws a two-dimensional object by projecting the three-dimensional model in the three-dimensional space onto a two-dimensional plane; a label generating unit that generates a label from the attributes associated with the three-dimensional model from which the two-dimensional object is projected; a background synthesizing unit that generates a two-dimensional image by synthesizing the two-dimensional object and a second background; and a training data generating unit that generates training data that associates the two-dimensional image in which the second background and the two-dimensional object are synthesized with the generated label.

A training data generating method according to the present invention includes: generating a three-dimensional space modeling a three-dimensional model with associated attributes and a first background in a virtual space; drawing a two-dimensional object by projecting the three-dimensional model in the three-dimensional space onto a two-dimensional plane; generating a label from the attributes associated with the three-dimensional model from which the two-dimensional object is projected; generating a two-dimensional image by synthesizing the two-dimensional object and a second background; and generating training data that associates the two-dimensional image in which the second background and the two-dimensional object are synthesized with the generated label.

A training data generating program according to the present invention causes a computer to execute: three-dimensional space generating processing of generating a three-dimensional space modeling a three-dimensional model with associated attributes and a first background in a virtual space; two-dimensional object drawing processing of drawing a two-dimensional object by projecting the three-dimensional model in the three-dimensional space onto a two-dimensional plane; label generating processing of generating a label from the attributes associated with the three-dimensional model from which the two-dimensional object is projected; background synthesizing processing of generating a two-dimensional image by synthesizing the two-dimensional object and a second background; and training data generating processing of generating training data that associates the two-dimensional image in which the second background and the two-dimensional object are synthesized with the generated label.

### Advantageous Effects of Invention

According to the present invention, it is possible to automatically generate training data with correct labels assigned according to types of data from CG.

### BRIEF DESCRIPTION OF DRAWINGS

FIG. 1 It depicts a block diagram illustrating an exemplary embodiment of a training data generator according to the present invention.

FIG. 2 It depicts an explanatory diagram illustrating an example of training data.

FIG. 3 It depicts a flowchart illustrating an operation example of the training data generator.

FIG. 4 It depicts an explanatory diagram illustrating an example of the operation of generating training data.

FIG. 5 It depicts a block diagram illustrating an outline of the training data generator according to the present invention.

### DESCRIPTION OF EMBODIMENTS

Hereinafter, an exemplary embodiment of the present invention will be described with reference to the drawings.

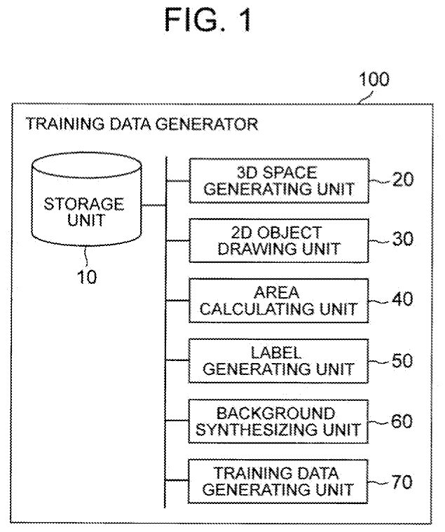

FIG. 1 is a block diagram illustrating an exemplary embodiment of a training data generator according to the present invention. The training data generator 100 according to the present exemplary embodiment includes a storage unit 10, a 3D (three-dimensional) space generating unit 20, a 2D (two-dimensional) object drawing unit 30, an area calculating unit 40, a label generating unit 50, a background synthesizing unit 60, and a training data generating unit 70.

The storage unit 10 stores information (parameters) of various objects and backgrounds for generating a 3D space described below, as well as information (parameters) on the background used for synthesis. The storage unit 10 may also store the generated training data. The storage unit 10 is realized by, for example, a magnetic disk.

The 3D space generating unit 20 generates a 3D space in which a 3D model and a background are modeled in a virtual space. Specifically, the 3D space generating unit 20 generates images of the 3D space using a tool or program that generates 3D computer graphics. The 3D space generating unit 20 may also generate the 3D space using a general method of generating 3D computer graphics.

The 3D model is an object that exists in 3D space, such as a person or a vehicle. The 3D model is also associated with information that represents the attributes of the 3D model. Examples of attributes include the type and color of the object, gender, age, and various other factors.

The following is a specific explanation of an example of the process by which the 3D space generating unit 20 generates a 3D space. Here, an example is shown in which a 3D space is generated assuming that a person moves. First, the 3D space generating unit 20 inputs a background CG and a person CG, and synthesizes the background and the person on the CG Attribute information such as gender and clothing is associated with the person CG.

In addition, the 3D space generating unit 20 inputs the motion of the person CG The background CG, the person CG, and the motion of the person are specified by the user or others. The 3D space generating unit 20 may also input parameters representing the viewpoint for the 3D space, parameters representing the light source such as ambient light, and information representing the texture and shading of the object. The 3D space generating unit 20 then performs rendering (image or video generation) based on the input information.

Further, the 3D space generating unit 20 may input one or both of the parameter pattern indicating a plurality of viewpoints to be changed (Hereafter, it is referred to as a viewpoint change pattern) and the parameter pattern indicating a plurality of ambient lights to be changed (Hereafter, it is referred to as an ambient light change pattern.) In this case, the 3D space generating unit 20 may generate a 3D space for each input viewpoint change pattern and ambient light change pattern. By inputting such patterns, it is possible to easily generate a 3D space assuming numerous environments.

The 2D object drawing unit 30 draws a 2D object by projecting a 3D model in 3D space onto a 2D plane. The method by which the 2D object drawing unit 30 draws the 3D model as a 2D object is arbitrary. For example, the 2D object drawing unit 30 may draw as the 2D object a point group converted from the 3D model by perspective projection transformation from within the 3D space to the viewpoint. The method of transforming a three-dimensional model by perspective projection transformation is widely known, and a detailed explanation is omitted here.

The 2D object drawing unit 30 may draw the 2D object by projecting the 3D model onto a 2D plane defined by a single color. By drawing the 2D object onto a 2D plane of a single color, it becomes easier to identify the area of the 2D object by the area calculating unit 40 described below.

The area calculating unit 40 calculates an area where the 2D object exists for each drawn 2D object. Specifically, the area calculating unit 40 may calculate a circumscribed rectangle coordinate of the 2D object for each drawn 2D object as the area where the object exists.

When a 2D object is drawn as a point group by perspective projection transformation, the area calculating unit 40 may calculate the area where the 2D object exists based on the drawn point group. For example, the area calculating unit 40 may calculate the drawn point group itself as the area where the object exists, or may calculate the circumscribed rectangle coordinate of the point group as the area where the object exists.

Furthermore, when a 2D object is drawn on a 2D plane defined by a single color, the area calculating unit 40 may calculate the circumscribed rectangle coordinate surrounding the defined area other than the single color as the area where the object exists.

The label generating unit 50 generates a label from the attributes associated with the 3D model from which the 2D object is projected. The generated labels may be some or more of the associated attributes. The label generating unit 50 may also generate a new label based on the associated attributes. For example, if the attribute includes “gender (male or female),” the label generating unit 50 may generate a new label indicating whether the person is male or female, or whether the person is female or not, as a new label.

The background synthesizing unit 60 generates a 2D image by synthesizing the 2D object and a background. The background synthesized by the background synthesizing unit 60 may be the same as or different from the background used by the 3D space generating unit 20 to generate the 3D space. In the following description, in order to distinguish between the background used by the 3D space generating unit 20 to generate the 3D space and the background synthesized by the background synthesizing unit 60 with the 2D object, the former background may be referred to as the first background, and the latter background may be referred to as the second background.

In order to avoid a sense of discomfort when the second background and the 2D object are synthesized, it is preferable that the background synthesizing unit 60 generates a 2D image that synthesizes the 2D object with the second background defined by the same parameters as the viewpoint parameter and ambient light parameter when the 2D object is drawn.

The training data generating unit 70 generates training data that associates the 2D image in which the second background and the 2D object are synthesized with the generated label. Furthermore, the training data generating unit 70 may generate training data that associates the calculated area in addition to the 2D image and the label.

The content of the training data generated by the training data generating unit 70 may be predetermined according to the information required for machine learning. For example, in the case of learning a model that performs object recognition, the training data generating unit 70 may generate training data that associates the coordinate values of an object in a two-dimensional plane with an image. Also, for example, in the case of learning a model that determines gender in addition to object recognition, the training data generating unit 70 may generate training data that associates the coordinate values of the object in the 2D plane, the image, and the label indicating male or female.

The training data generating unit 70 may extract from the generated training data only the training data that is associated with a label that matches the desired condition. For example, if it is desired to extract only the training data that includes a man wearing a suit, the training data generating unit 70 may extract only the training data that is associated with a label indicating “a man wearing a suit” from the generated training data. By extracting such training data, for example, it is possible to learn a model for clothing recognition.

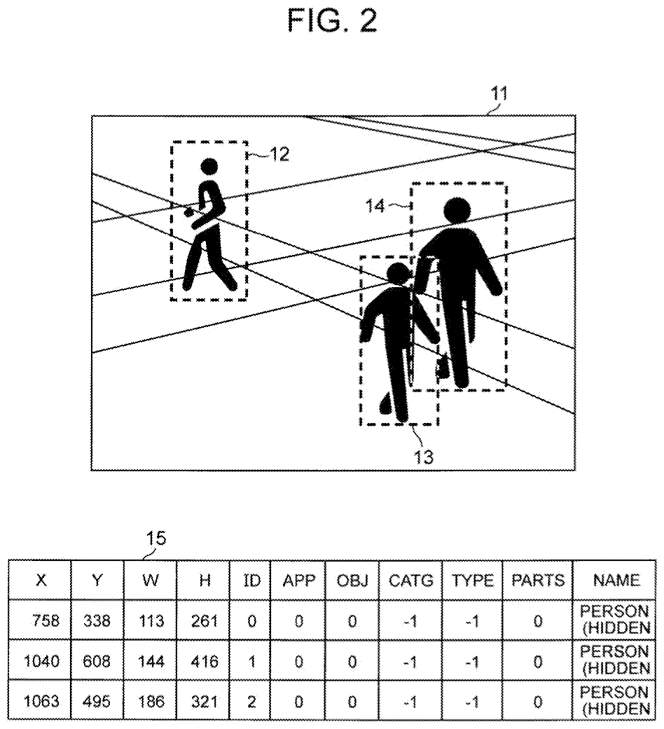

FIG. 2 is an explanatory diagram illustrating an example of training data. The image 11 illustrated in FIG. 2 is an example of a 2D image generated by the background synthesizing unit 60. The example illustrated in FIG. 2 indicates that the image 11 contains three types of 2D objects (2D object 12, 2D object 13, and 2D object 14).

The label 15 illustrated in FIG. 2 is an example of a label that is associated with a 2D image. In the example illustrated in FIG. 2, the label 15 contains a label for each 2D object, and each row of the label 15 indicates a label for each 2D object.

In the label 15 illustrated in FIG. 2, X, Y indicate the coordinate values (X, Y) of each 2D object in the 2D image when the upper left is the origin, and W, H indicate the width and height of the 2D object, respectively. ID indicates the identifier of the 2D object in the image corresponding to the 3D model, and PARTS indicates the identifier of the individual 3D model (object). NAME indicates the specific name of the individual 3D model.

As illustrated in the label 15 (APP, OBJ, TYPE, CATG) in FIG. 2, the direction of the object, the direction of travel, the category of the object (e.g., scooter, etc.) and the specific product name, etc. may be set in the label. For example, if the object (OBJ) in the 3D model is a motorcycle, the category (CATG) is set to scooter, etc., the type is set to the product name of the scooter, etc., and the parts (PARTS) are set to tires, handlebars, etc.

The way in which the training data generating unit 70 associates 2D images with labels is arbitrary. For example, if one object exists in one 2D image, the training data generating unit 70 may generate training data in which one label is associated with one 2D image. In this case, if the area in which the object exists is clear (for example, one object exists in the entire image), the training data generating unit 70 may not need to associate the area with the training data.

In the case where multiple objects exist in one 2D image, the training data generating unit 70 may generate training data in which a plurality of labels including corresponding areas in the image are associated with one 2D image. In this case, each label may include information that identifies the corresponding 2D image. Generating the training data in this way can reduce the amount of storage required to store the images.

On the other hand, in the case when multiple objects exist in one 2D image, the training data generating unit 70 may extract partial images corresponding to the area (e.g., rectangular area) where the objects exist from the 2D image and generate training data in which the extracted partial image and the label are associated with each other. In this case, the training data generating unit 70 may not need to associate the area with the training data. In addition, each label may include information that identifies the partial image to be associated (e.g., file name, etc.). By generating the training data in this way, it is possible to retain the training data with labels set corresponding to individual 2D images (partial images) while reducing the amount of storage for storing images.

In this exemplary embodiment, the case where the area calculating unit 40 calculates the area where the 2D object exists is described. However, in the case of generating training data that does not require the setting of an area as described above, the training data generator 100 may not have to include the area calculating unit 40.

The 3D space generating unit 20, 2D the object drawing unit 30, the area calculating unit 40, the label generating unit 50, the background synthesizing unit 60, and the training data generating unit 70 are realized by a computer processor (for example, a central processing unit (CPU), a graphics processing unit (GPU)) that operates according to a program (a training data generating program).

The above-mentioned program may be stored in, for example, the storage unit 10, and the processor may read the program, and operate, in accordance with the program, as the 3D space generating unit 20, the 2D object drawing unit 30, the area calculating unit 40, the label generating unit 50, the background synthesizing unit 60, the and training data generating unit 70. Further, a function of the training data generator 100 may be provided in a software as a service (SaaS) format.

The 3D space generating unit 20, the 2D object drawing unit 30, the area calculating unit 40, the label generating unit 50, the background synthesizing unit 60, and the training data generating unit 70 may each be realized by dedicated hardware. In addition, part or all of each constituent element of each device may be realized by a general purpose or dedicated circuitry, a processor, or the like, or a combination thereof. These may be configured by a single chip or may be configured by a plurality of chips connected via a bus. Part or all of each constituent element of each device may be realized by a combination of the above-described circuitry and the like and a program.

Further, when part or all of each constituent element of the training data generator 100 is realized by a plurality of information processing devices, circuitry, and the like, the plurality of information processing devices, circuitry, and the like may be arranged concentratedly or distributedly. For example, the information processing devices, the circuitry, and the like may be realized as a form in which each is connected via a communication network, such as a client server system, a cloud computing system, and the like.

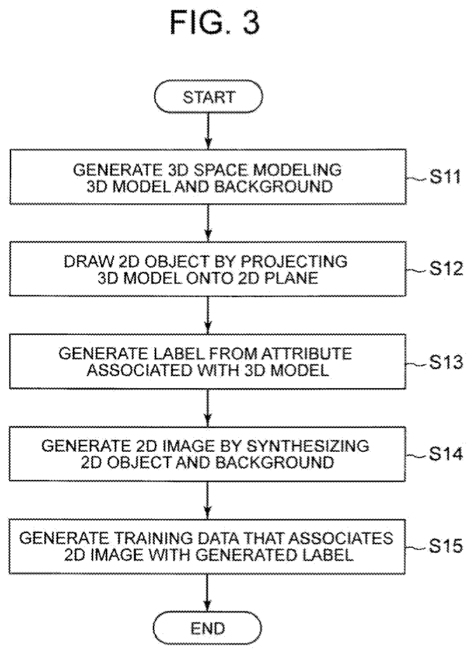

Next, a description will be given of an operation of the training data generator of the present exemplary embodiment. FIG. 3 is a flowchart illustrating an operation example of the training data generator 100 according to the present exemplary embodiment.

The 3D space generating unit 20 generates a 3D space modeling a 3D model with associated attributes and a background in a virtual space (Step S11). The 2D object drawing unit 30 draws a 2D object by projecting the 3D model in the 3D space onto a 2D plane (Step S12). The area calculating unit 40 may calculate the area where the 2D object exists for each 2D object drawn.

The label generating unit 50 generates a label from the attributes associated with the 3D model from which the 2D object is projected (Step S13). The background synthesizing unit 60 generates a 2D image by synthesizing the 2D object and a second background (Step S14). Then, the training data generating unit 70 generates training data that associates the 2D image in which the background and the 2D object are synthesized with the generated label (Step S15).

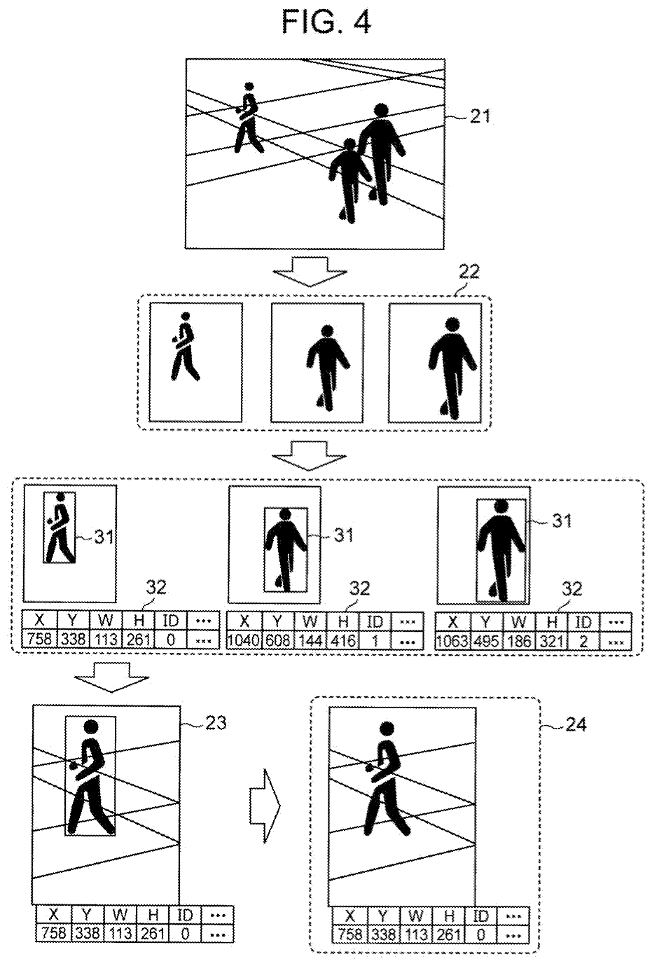

Next, a specific example of the training data generating process in this exemplary embodiment will be described. FIG. 4 is an explanatory diagram illustrating an example of the operation of generating training data. First, the 3D space generating unit 20 generates an image 21 of a 3D space in which a plurality of persons, which are 3D models, and a background are synthesized. The 2D object drawing unit 30 draws a 2D person by projecting the person in the 3D space indicated by the image 21 onto a 2D plane to generate a 2D image 22.

The area calculating unit 40 calculates an area 31 in which the person exists for each drawn person. The label generating unit 50 generates a label 32 from the attributes of the person. The background synthesizing unit 60 generates a 2D image 23 in which the person and the background are synthetized. In FIG. 4, an example of generating a 2D image synthesizing a person identified by ID=0 of the label and the background is shown. The same method is used to generate a 2D image synthesizing the person identified by ID=1 and ID=2 of the label and the background. Then, the training data generating unit 70 generates training data that associates the 2D image 23 in which the background and the person are synthesized and the generated label 32.

As described above, in this exemplary embodiment, the 3D space generating unit 20 generates a 3D space modeling a 3D with associated attributes and a first background in a virtual space, and the 2D object drawing unit 30 draws a 2D object by projecting the 3D model in the 3D space onto a 2D plane. In addition, the label generating unit 50 generates a label from the attributes associated with the 3D model from which the 2D object is projected, and the background synthesizing unit 60 generates a 2D image by synthesizing the 2D object and a second background. Then, the training data generating unit 70 generates training data that associates the 2D image in which the second background and the 2D object are synthesized with the generated labels. Thus, it is possible to automatically generate training data with correct labels assigned according to types of data from CG.

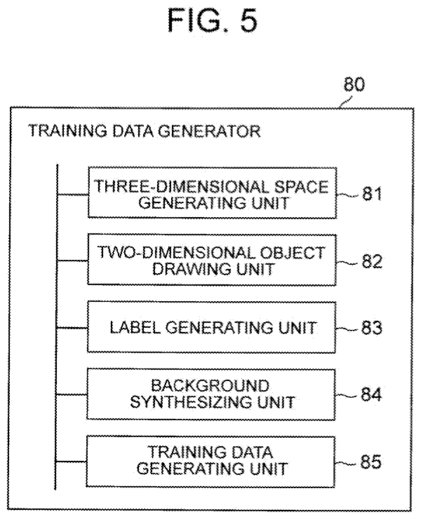

Next, an outline of the present invention will be described. FIG. 5 is a block diagram illustrating an outline of the training data generator according to the present invention. A training data generator 80 (for example, training data generator 100) according to the present invention includes a three-dimensional space generating unit 81 (for example, 3D space generating unit 20) that generates a three-dimensional space modeling a three-dimensional model with associated attributes and a first background in a virtual space, a two-dimensional object drawing unit 82 (for example, 2D object drawing unit 30) that draws a two-dimensional object by projecting the three-dimensional model in the three-dimensional space onto a two-dimensional plane, a label generating unit 83 (for example, label generating unit 50) that generates a label from the attributes associated with the three-dimensional model from which the two-dimensional object is projected, a background synthesizing unit 84 (for example, background synthesizing unit 60) that generates a two-dimensional image by synthesizing the two-dimensional object and a second background, and a training data generating unit 85 (for example, training data generating unit 70) that generates training data that associates the two-dimensional image in which the second background and the two-dimensional object are synthesized with the generated label.

With such a configuration, it is possible to automatically generate training data with correct labels assigned according to types of data from CG.

The training data generator 80 may include an area calculating unit (for example, area calculating unit 40) that calculates an area where the two-dimensional object exists for each two-dimensional object drawn. Then the training data generating unit 85 may generate the training data that associates the two-dimensional image, the label, and the area.

Specifically, the area calculating unit may calculate a circumscribed rectangle coordinate of the two-dimensional object for each drawn two-dimensional object as the area where the object exists.

The two-dimensional object drawing unit 82 may draw the two-dimensional object by projecting the three-dimensional model onto a two-dimensional plane defined by a single color, and the area calculating unit may calculate the circumscribed rectangle coordinate surrounding the defined area other than the single color as the area where the object exists.

The two-dimensional object drawing unit 82 may draw as the two-dimensional object a point group converted from the three-dimensional model by perspective projection transformation from within the three-dimensional space to the viewpoint, and the area calculating unit may calculate the area where the two-dimensional object exists based on the drawn point group.

The background synthesizing unit 84 may generate a two-dimensional image by synthesizing the two-dimensional object and the background defined by the same parameters as a viewpoint parameter and an ambient light parameter when the two-dimensional object is drawn.

The three-dimensional space generating unit 81 may generate a three-dimensional space for each viewpoint change pattern, which is a pattern of parameters indicating a plurality of viewpoints to be changed, and for each ambient light change pattern, which is a pattern of parameters indicating a plurality of ambient lights to be changed.

Some or all of the above exemplary embodiments may be described as in the following supplementary notes, but are not limited to the following.
(Supplementary Note 1) A training data generator, comprising: a three-dimensional space generating unit that generates a three-dimensional space modeling a three-dimensional model with associated attributes and a first background in a virtual space; a two-dimensional object drawing unit that draws a two-dimensional object by projecting the three-dimensional model in the three-dimensional space onto a two-dimensional plane; a label generating unit that generates a label from the attributes associated with the three-dimensional model from which the two-dimensional object is projected; a background synthesizing unit that generates a two-dimensional image by synthesizing the two-dimensional object and a second background; and a training data generating unit that generates training data that associates the two-dimensional image in which the second background and the two-dimensional object are synthesized with the generated label.
(Supplementary Note 2) The training data generator according to Supplementary note 1, further comprising an area calculating unit that calculates an area where the two-dimensional object exists for each two-dimensional object drawn, wherein the training data generating unit generates the training data that associates the two-dimensional image, the label, and the area.
(Supplementary Note 3) The training data generator according to Supplementary note 2, wherein the area calculating unit calculates a circumscribed rectangle coordinate of the two-dimensional object for each drawn two-dimensional object as the area where the object exists.
(Supplementary Note 4) The training data generator according to Supplementary note 2 or 3, wherein the two-dimensional object drawing unit draws the two-dimensional object by projecting the three-dimensional model onto a two-dimensional plane defined by a single color, and the area calculating unit calculates the circumscribed rectangle coordinate surrounding the defined area other than the single color as the area where the object exists.
(Supplementary Note 5) The training data generator according to any one of Supplementary notes 2 to 4, wherein the two-dimensional object drawing unit draws as the two-dimensional object a point group converted from the three-dimensional model by perspective projection transformation from within the three-dimensional space to the viewpoint, and the area calculating unit calculates the area where the two-dimensional object exists based on the drawn point group.
(Supplementary Note 6) The training data generator according to any one of Supplementary notes 1 to 5, wherein the background synthesizing unit generates a two-dimensional image by synthesizing the two-dimensional object and the background defined by the same parameters as a viewpoint parameter and an ambient light parameter when the two-dimensional object is drawn.
(Supplementary Note 7) The training data generator according to any one of Supplementary notes 1 to 6, wherein the three-dimensional space generating unit generates a three-dimensional space for each viewpoint change pattern, which is a pattern of parameters indicating a plurality of viewpoints to be changed, and for each ambient light change pattern, which is a pattern of parameters indicating a plurality of ambient lights to be changed.
(Supplementary Note 8) A training data generating method comprising: generating a three-dimensional space modeling a three-dimensional model with associated attributes and a first background in a virtual space; drawing a two-dimensional object by projecting the three-dimensional model in the three-dimensional space onto a two-dimensional plane; generating a label from the attributes associated with the three-dimensional model from which the two-dimensional object is projected; generating a two-dimensional image by synthesizing the two-dimensional object and a second background; and generating training data that associates the two-dimensional image in which the second background and the two-dimensional object are synthesized with the generated label.
(Supplementary Note 9) The training data generating method according to Supplementary note 8, further comprising: calculating an area where the two-dimensional object exists for each two-dimensional object drawn; and generating the training data that associates the two-dimensional image, the label, and the area.
(Supplementary Note 10) A training data generating program causing a computer to execute: three-dimensional space generating processing of generating a three-dimensional space modeling a three-dimensional model with associated attributes and a first background in a virtual space; two-dimensional object drawing processing of drawing a two-dimensional object by projecting the three-dimensional model in the three-dimensional space onto a two-dimensional plane; label generating processing of generating a label from the attributes associated with the three-dimensional model from which the two-dimensional object is projected; background synthesizing processing of generating a two-dimensional image by synthesizing the two-dimensional object and a second background; and training data generating processing of generating training data that associates the two-dimensional image in which the second background and the two-dimensional object are synthesized with the generated label.
(Supplementary Note 11) The training data generating program according to Supplementary note 10, wherein the training data generating program causes the computer to further execute area calculating processing of calculating an area where the two-dimensional object exists for each two-dimensional object drawn, and wherein, in the training data generating processing, the training data that associates the two-dimensional image, the label, and the area is generated.

### REFERENCE SIGNS LIST

10 storage unit
20 3D space generating unit
30 2D object drawing unit
40 area calculating unit
50 label generating unit
60 background synthesizing unit
70 training data generating unit
100 training data generator

What is claimed is:

1. A training data generator, comprising a hardware processor configured to execute a software code to:
generate a three-dimensional space modeling a three-dimensional model with associated attributes and a first background in a virtual space;
draw a two-dimensional object by projecting the three-dimensional model in the three-dimensional space onto a two-dimensional plane;
generate a label from the attributes associated with the three-dimensional model from which the two-dimensional object is projected;
generate a two-dimensional image by synthesizing the two-dimensional object and a second background; and
generate raining data that associates the two-dimensional image in which the second background and the two-dimensional object are synthesized with the generated label.

2. The training data generator according to claim 1, wherein the hardware processor is configured to execute a software code to:
calculate an area where the two-dimensional object exists for each two-dimensional object drawn, drawn; and
generate the training data that associates the two-dimensional image, the label, and the area.

3. The training data generator according to claim 2, wherein the hardware processor is configured to execute a software code to
calculate a circumscribed rectangle coordinate of the two-dimensional object for each drawn two-dimensional object as the area where the object exists.

4. The training data generator according to claim 2, wherein the hardware processor is configured to execute a software code to:
draw the two-dimensional object by projecting the three-dimensional model onto a two-dimensional plane defined by a single; and
calculate the circumscribed rectangle coordinate surrounding the defined area other than the single color as the area where the object exists.

5. The training data generator according to claim 2, wherein the hardware processor is configured to execute a software code to:
draw as the two-dimensional object a point group converted from the three-dimensional model by perspective projection transformation from within the three-dimensional space to the viewpoint; and
calculate the area where the two-dimensional object exists based on the drawn point group.

6. The training data generator according to claim 1, wherein the hardware processor is configured to execute a software code to
generate a two-dimensional image by synthesizing the two-dimensional object and the background defined by the same parameters as a viewpoint parameter and an ambient light parameter when the two-dimensional object is drawn.

7. The training data generator according to claim 1, wherein the hardware processor is configured to execute a software code to
generate a three-dimensional space for each viewpoint change pattern, which is a pattern of parameters indicating a plurality of viewpoints to be changed, and for each ambient light change pattern, which is a pattern of parameters indicating a plurality of ambient lights to be changed.

8. A training data generating method comprising:
generating a three-dimensional space modeling a three-dimensional model with associated attributes and a first background in a virtual space;
drawing a two-dimensional object by projecting the three-dimensional model in the three-dimensional space onto a two-dimensional plane;
generating a label from the attributes associated with the three-dimensional model from which the two-dimensional object is projected;
generating a two-dimensional image by synthesizing the two-dimensional object and a second background; and
generating training data that associates the two-dimensional image in which the second background and the two-dimensional object are synthesized with the generated label.

9. The training data generating method according to claim 8, further comprising:
calculating an area where the two-dimensional object exists for each two-dimensional object drawn; and
generating the training data that associates the two-dimensional image, the label, and the area.

10. A non-transitory computer readable information recording medium storing a training data generating program, when executed by a processor, that performs a method for:
generating a three-dimensional space modeling a three-dimensional model with associated attributes and a first background in a virtual space;
drawing a two-dimensional object by projecting the three-dimensional model in the three-dimensional space onto a two-dimensional plane;
generating a label from the attributes associated with the three-dimensional model from which the two-dimensional object is projected;
generating a two-dimensional image by synthesizing the two-dimensional object and a second background; and
generating training data that associates the two-dimensional image in which the second background and the two-dimensional object are synthesized with the generated label.

11. The non-transitory computer readable information recording medium according to claim 10, further comprising:
calculating an area where the two-dimensional object exists for each two-dimensional object; and
generating the training data that associates the two-dimensional image, the label, and the area.
